(19) United States
(12) Patent Application Publication
(10) Pub. No.: US 2005/0066013 A1
(43) Pub. Date: Mar. 24, 2005

(54) Systems and methods for providing support to a user regarding print quality

(76) Inventor: Dave R. Dehart, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/659,594

(22) Filed: Sep. 10, 2003

(51) Int. Cl. G06F 15/16

(52) U.S. Cl. 709/218

(57) ABSTRACT

Disclosed are systems and methods for providing print quality support to a device user. In one embodiment, a system and a method pertain to presenting a link to print quality support in a device driver user interface, and providing print quality support to the user when the link is selected by the user.

### BACKGROUND

Many peripheral devices are configured to output printed media. For example, peripheral printing devices, such as printers, multifunction peripheral (MFP) devices, and copiers are configured to draw media from an input tray and print data on the media to generate hard copy documents.

When a peripheral device user experiences a problem with the print quality of a printed output, the user may consult various resources to obtain device support. For instance, user manuals are often provided along with printing devices that explain how to use the printing device correctly and how to troubleshoot print quality problems. In addition, the same or similar information is often made available online at, for example, a manufacturer's web site. Unfortunately, it is typically difficult and/or tedious for users to find the information they need. For example, in the case of user manuals, such manuals are typically long and not very user friendly. Similarly, in the case of online web sites, it can be difficult for the user to locate the needed infonnation in the morass of information that typically is provided in a given web site.

In view of the difficulty with locating information regarding print quality, users often resort to contacting the manufacturer. This requires the device manufacturer to expend large amounts of money to provide user support, often for problems that could easily have been fixed by the user if the user would have had convenient access to the required support information. In other cases, the user may replace various parts of the printing device in an attempt to remedy the problem. Unfortunately, the user may purchase replacement parts for existing parts that are still in proper working condition. Therefore, the user may waste time and money replacing device parts, all without fixing the problem. This leads to user frustration and dissatisfaction with the device manufacturer. Therefore, it can be appreciated that it would be desirable to have a convenient way for users to access print quality support for a peripheral device.

### SUMMARY

Disclosed are systems and methods for providing print quality support to a device user. In one embodiment, a system and a method pertain to presenting a link to print quality support in a device driver user interface, and providing print quality support information to the user when the link is selected by the user.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of a system with which support can be provided to a peripheral device user.

FIG. 2 is a block diagram of an embodiment of a user computer shown in FIG. 1.

FIG. 3 is a flow diagram that illustrates an embodiment of a method for providing support to a peripheral device user.

FIG. 4 is a flow diagram that illustrates an embodiment of operation of a peripheral device driver of the user computer of FIG. 2.

FIG. 5 is a schematic depiction of a user interface associated with the peripheral device driver of the user computer of FIG. 2.

### DETAILED DESCRIPTION

As described above, it is typically difficult and/or tedious for peripheral device users to find the infonnation they need regarding print quality issues for their peripheral devices. However, as is disclosed herein, if access to such support is incorporated into the device driver user interface, the needed information can be provided to the user at a place at which the user is likely to see it.

Disclosed herein are embodiments of systems and methods for providing print quality support to a user. Although particular embodiments are disclosed, these embodiments are provided for purposes of example only to facilitate description of the disclosed systems and methods.

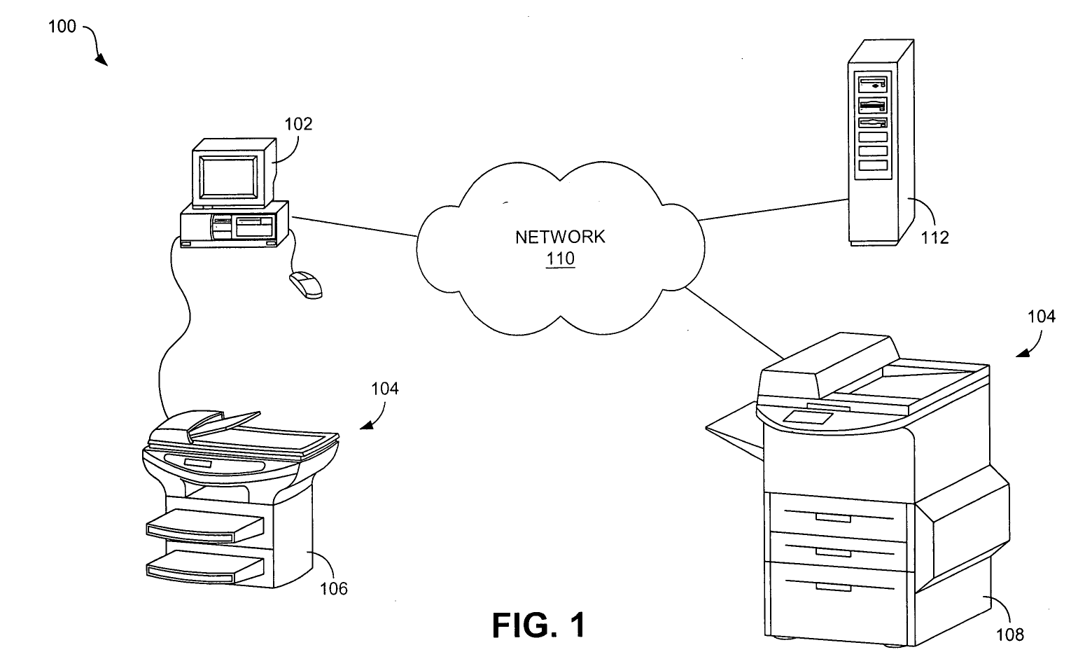

Referring now in more detail to the drawings, in which like numerals indicate corresponding parts throughout the several views, FIG. 1 illustrates a system 100 for providing support to a peripheral device user. As indicated in that figure, the system 100 comprises a user computer 102, such as a desktop personal computer (PC), and one or more peripheral devices 104 with which the computer can communicate. As shown in FIG. 1, the peripheral devices 104 comprise printing devices that can generate hard copy output. Such printing devices can comprise a local printing device that is directly connected to the user computer 102, such as a multifunction peripheral (MFP) device 106 that is capable of multiple functionalities such as printing, copying, scanning, emailing, and faxing and is connected to the user computer 102. Alternatively or in addition, the printing devices can include a remote printing device, such as a printer 108, that the user computer 102 communicates with via a network 110.

In addition to the above-noted components, the system 100 may further comprise a remote computer 112. By way of example, the remote computer 112 comprises a network server that stores various information about the peripheral devices 104. Optionally, the remote computer 112 may be maintained by or on the behalf of the manufacturer of the peripheral devices 104.

The network 110 may comprise one or more of a local area network (LAN) and a wide area network (WAN). Moreover, the network 110 may comprise a plurality of sub-networks that together form a part of the Internet. In such a case, the remote computer 112 may comprise a web server.

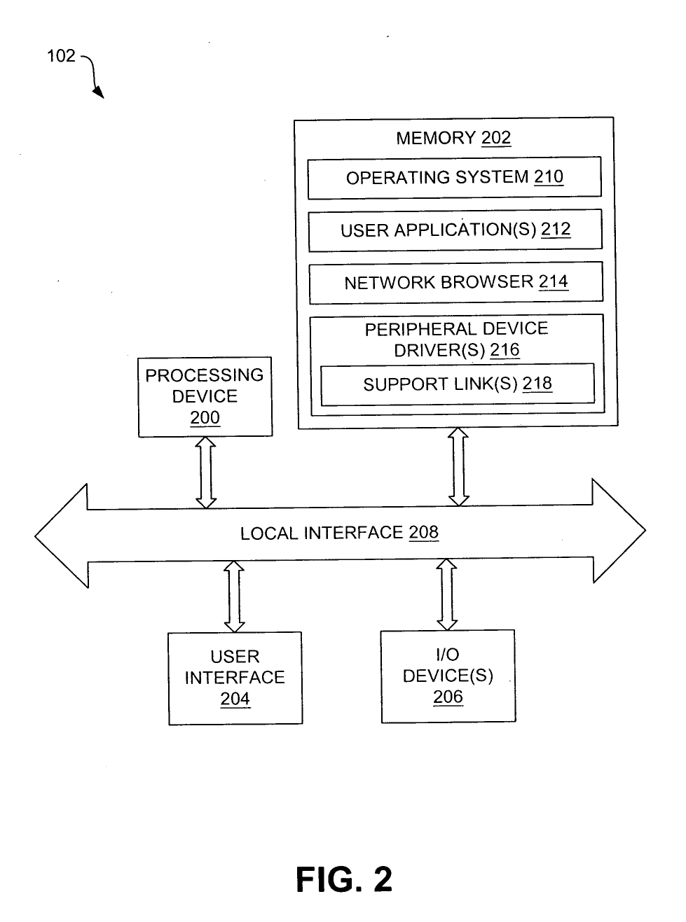

FIG. 2 is a block diagram that illustrates an example architecture for the user computer 102. As indicated in FIG. 2, the user computer 102 comprises a processing device 200, memory 202, a user interface 204, and at least one input/output I/O device 206, each of which is connected to a local interface 208.

The processing device 200 can include a central processing unit (CPU) or an auxiliary processor among several processors associated with the computer 102, or a semiconductor-based microprocessor (in the form of a microchip). The memory 202 includes any one of or a combination of volatile memory elements (e.g., RAM) and nonvolatile memory elements (e.g., read only memory (ROM), hard disk, tape, etc.).

The user interface 204 comprises the components with which a user interacts with the user computer 102, such as a keyboard and mouse, and a device that provides visual information to the user, such as a cathode ray tube (CRT) or liquid crystal display (LCD) monitor.

With further reference to FIG. 2, the one or more I/O devices 206 are adapted to facilitate communication with other devices, including the peripheral devices 104. By way of example, the I/O devices 206 may include one or more of a universal serial bus (USB), a Firewire, or a small computer system interface (SCSI) connection component and/or network communication components such as a modem or a network card.

The memory 202 comprises various programs including an operating system 210, at least one user application 212, a network browser 214, and at least one peripheral device driver 216. The operating system 210 controls the execution of other programs and provides scheduling, input-output control, file and data management, memory management, and communication control and related services. The at least one user application 212 comprises one or more programs with which the user may generate data to be provided to the peripheral device for printing. For example, the at least one user application 212 may comprise a word processing application and a computer-aided drawing (CAD) program with which textural and graphical print data can be generated.

The network browser 214 is a program that enables the user to collect and view data accessible via a network, such as the Internet. By way of example, the network browser 214 comprises an Internet browser such as Microsoft Internet Explorer™ or Netscape Navigator™.

Each peripheral device driver 216 comprises a program that is used to control and operate a peripheral device. The drivers 216 comprise code that acts in the capacity of translators between programs that execute on the user computer 102 (e.g., user applications 212) and the peripheral device for which the driver is designed. The drivers 216 therefore accept generic commands from a program, and then translate the commands into specialized commands for the peripheral device. In addition to that code, the driver 216 comprises the various code used to support a user interface (described below) that enables the user to make various peripheral device selections.

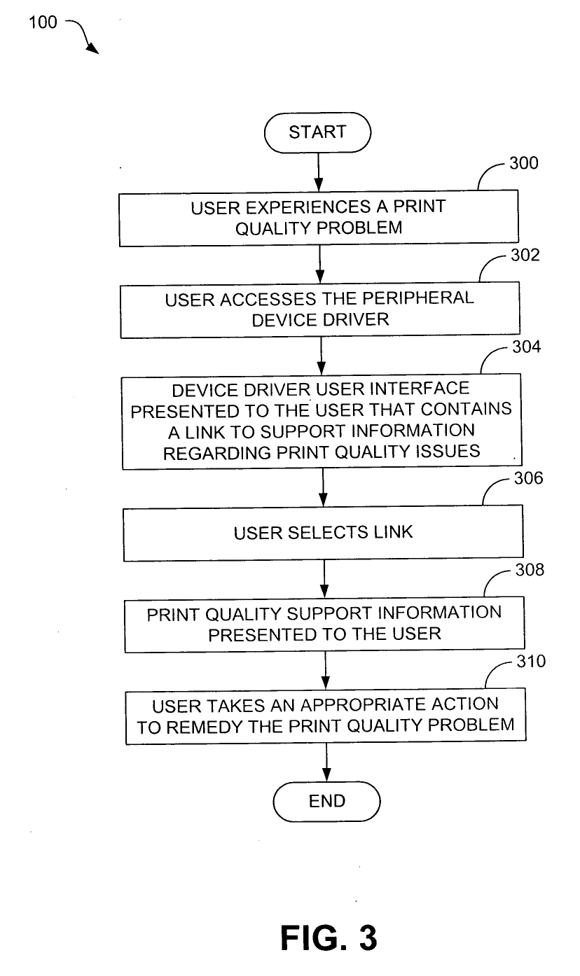

As is indicated in FIG. 2, each peripheral device driver 216 includes one or more support links 218 that facilitate the provision of support to a user. As is described in greater detail below, the support links 218 can comprise hyperlinks that access a remote computer (e.g., web server) of the manufacturer of the peripheral device. More particularly, the support links 218 can comprise hyperlinks that take the user to one or more particular network pages (e.g., web pages) of a network site (e.g., web site) that provide information pertinent to print quality issues. Such operation is described below in relation to FIGS. 3-5.

Various programs (i.e., logic) have been described herein. These programs can be stored on any computer-readable medium for use by or in connection with any computer-related system or method. In the context of this document, a computer-readable medium is an electronic, magnetic, optical, or other physical device or means that contains or stores a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

Example systems having been described above, operation of the systems will now be discussed. In the discussions that follow, flow diagrams are provided. Process steps or blocks in these flow diagrams may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

FIG. 3 provides an overview of an example of providing support to a peripheral device user in the context of the system 100 shown in FIG. 1. More particularly, FIG. 3 provides an overview of an example of providing support to a printing device user regarding print quality issues. Beginning with block 300 of FIG. 3, the user experiences a print quality problem. In particular, the user attempts to print a document, such as a color document, and obtains an output that is considered unacceptable to the user in terms of quality. For example, text of the printed document may not be sharp, undesired marks may appear on the document, the colors of a color document may run together, the colors of a color document may not appear to be the correct shades, etc.

Next, at the user computer (e.g., computer 102 (FIG. 1)), the user accesses the peripheral device driver, as indicated in block 302. Usage research has been conducted that indicates that when a print quality problem is experienced, some users turn to the device driver for support in that the driver is the user's most familiar interface with the peripheral device. The user can access the driver by, for instance, selecting a “print” command from a user application. More particularly, the user may access the driver by selecting “file” from the user application to summon a drop-down menu, and then select a “print” option from the drop-down menu. Alternatively, the user may select a “printers” option from a control panel feature supported by the computer's O/S. Irrespective of the manner with which the user accesses the peripheral device driver, a device driver user interface is presented to the user as indicated in block 304. The user interface may, for instance, comprise one or more pop-up boxes that comprise selectable “tabs” pertaining to given printing device and/or print job options. By way of example, such tabs may comprise a “color” tab that the user is likely to consult when a print quality problem is encountered using a color printing device. In some cases, such tabs are presented to the user after the user selects an appropriate option that permits the user to make relatively low-level device selections, such as a “Properties” button.

As is further indicated in block 304, the device driver user interface contains a link to support information regarding print quality issues. In situations in which various types of information and/or options are provided with the user interface, such a link is provided at a location in the user interface at which the user is most likely to see it when seeking help for a print quality problem. By way of example, the link is provided in association with a color tab such as that described above. Regardless, the link can comprise, for example, a group of words or a support button that the user can select, for instance by “clicking” on the words or button using a mouse.

If the user would like to be provided with information regarding print quality issues, the user can select the link, as indicated in block 306. Next, with reference to block 308, print quality support information is presented to the user. In particular, information regarding proper usage of the printing device as well as troubleshooting information is presented to the user. By way of example, this support information can be presented in a document, site, or page that is accessed via a network and that can be viewed in a viewing window of a network browser that executes on the user computer. In such a case, the link may comprise a hyperlink to an appropriate web file, for instance maintained by or on the behalf of the peripheral device manufacturer. Selection of such a link causes a network browser to launch (if not already active) and retrieve the support information. In an alternative arrangement, selection of the link calls up a file already resident on the user computer (e.g., as part of the driver 216 (FIG. 2)).

The user can then peruse the presented support information. From that perusal, the user can determine why the print quality problem is being experienced. The user can take an appropriate action to remedy the problem, as indicated in block 310. Such action may comprise operating the peripheral device in a different manner and/or conducting troubleshooting tasks to pinpoint the source of the problem.

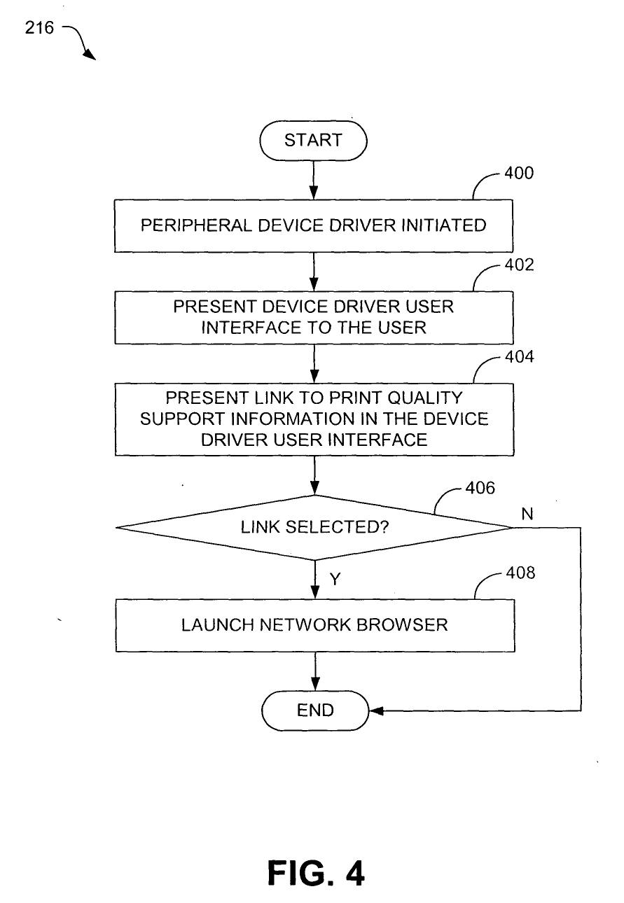

FIG. 4 provides an example of operation of a peripheral device driver 216 that executes on the user computer 102 (FIG. 2) in providing print quality support to a peripheral device user in regard to a given peripheral (e.g., printing) device. Beginning with block 400 of FIG. 4, the peripheral device driver 216 is initiated. As noted above, this initiation can occur upon the user selecting a “print” option or button from an appropriate user application 212, or by accessing a “printers” option from a control panel feature supported by the O/S 210. Once activated, the peripheral device driver 216 presents a device driver user interface to the user, as indicated in block 402. By way of example, the device driver user interface can comprise one or more pop-up boxes. The device driver user interface presents a link to print quality support infonnation, as indicated in block 404, at some location within the user interface. Such a link may be provided in association with an appropriate tab that is accessed by the user after selecting a “Properties” button of the user interface. For example, the link may be associated with a color tab of the device user interface.

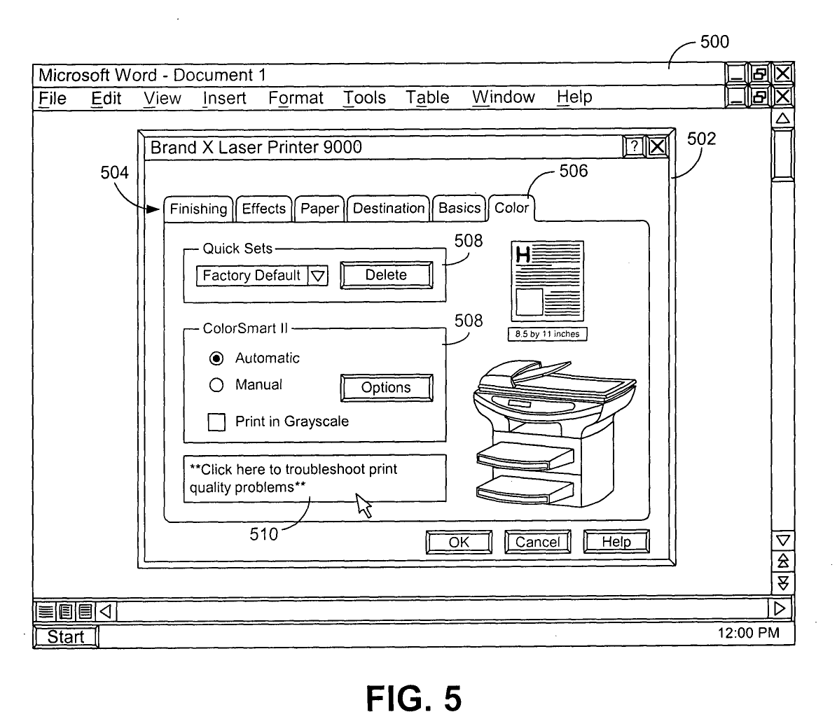

FIG. 5 provides an example of a device driver user interface in presenting a print quality support link. As indicated in FIG. 5, the user has arrived at the user interface from a window 500 of a user application, which in the example of FIG. 5 comprises Microsoft Word™. The device driver user interface comprises a pop-up box 502 that overlaps the user application window 500 and that includes various tabs 504 that lead to various options that the user can specify. As shown in FIG. 5, the user has selected a “Color” tab 506 that presents the user with various information and options regarding the color selections for the given peripheral device (the “Brand X Laser Printer 9000” in FIG. 5).

In the example of FIG. 5, the information and options are presented in windows 508 associated with the “Color” tab 506. In addition to the windows 508 is a link 510 that reads: “**Click here to troubleshoot print quality problems**”. By way of example, the link 510 comprises a hyperlink to a web document, site, or page.

Returning to FIG. 4, the peripheral device driver 216 determines whether the link is selected by the user, as indicated in decision block 406, for instance by “clicking” on the link using a mouse. If not, no action in providing information to the user regarding print quality is taken, and flow for the support session is terminated. If, on the other hand, the link is selected, the peripheral device driver 216 launches (or causes to be launched) the user's network browser 214, as indicated in block 408, such that appropriate support information is accessed by the browser and provided to the user. Again, the support information may be provided in a web document, site, or page. Such files may be accessed from the remote computer 112, which may, in some cases, comprise a web server.

By way of example, the support information may be contained within one or more web pages of a web site hosted by or on the behalf of the peripheral device manufacturer in such a case, the user need not conduct searches of the web site (which may be large and/or confusing to the user) and instead is sent directly to the information (e.g., page(s)) that the user wishes to obtain. The support information can comprise, for instance, information as to how to operate the peripheral device in a manner so as to receive high quality output. Such information may instruct the user as to proper driver settings for given media (e.g., paper, transparencies, envelopes, etc.), the proper types of media to use with the peripheral device, procedures to follow to obtain quality results (e.g., avoiding smudging transparencies with finger prints before printing), and the like. In addition, such information may provide troubleshooting tips for situations in which the user is operating the peripheral device properly, but is still observing print quality problems. For instance, the user may be instructed to check for undetected paper jams, to look for toner buildup and, if it is found, to clean the device, how to print troubleshooting test pages that aid the user in pinpointing a particular device component (e.g., print cartridge) that is causing the problem, how to recalibrate the peripheral device (e.g., by selecting a “calibrate now” command from the device control panel), and the like.

From the presented print quality support information, the user can acquire the knowledge that the user needs to remedy the encountered print quality problem. Therefore, acceptable print quality can be obtained by the user, potentially without the need to contact product support representatives and/or technicians and without having to purchase and install unnecessary replacement parts.

1. A method for providing print quality support to a device user, the method comprising:
presenting a link to print quality support in a device driver user interface; and
providing print quality support information to the user when the link is selected by the user.

2. The method of claim 1, wherein presenting a link comprises presenting a hyperlink to a network file.

3. The method of claim 2, wherein presenting a hyperlink to a network file comprises presenting a hyperlink to at least one of a web document, a web site, and a web page.

4. The method of claim 1, wherein presenting a link comprises presenting a link in association with a color tab of the device driver user interface.

5. The method of claim 1, wherein providing print quality support information comprises providing print quality support information in a network browser that retrieves the support information from a network.

6. The method of claim 1, wherein providing print quality support information comprises providing print quality support information retrieved from a web server by an Internet browser via the Internet.

7. The method of claim 1, wherein providing print quality support information comprises presenting information regarding at least one of proper device operation and troubleshooting tips.

8. A system for providing print quality support to a device user, the system comprising:
means for controlling a peripheral device from a user computer;
means for interfacing with the means for controlling; and
means, included within the means for interfacing, for presenting print quality support information obtained via a network.

9. The system of claim 8, wherein the means for controlling comprise a peripheral device driver that executes on the user computer.

10. The system of claim 8, wherein the means for interfacing comprise a device driver user interface that is presented to the user in a display of the user computer.

11. The system of claim 8, wherein the means for presenting print quality support information comprise a hyperlink to a network file.

12. The system of claim 11, wherein the means for presenting print quality support information further comprise a network browser with which the information may be viewed.

13. The system of claim 8, wherein the means for presenting print quality support information comprise means for presenting information regarding at least one of proper device operation and troubleshooting tips.

14. A system stored on a computer-readable medium, the system comprising:
logic configured to operate and control a peripheral device;
logic configured to support interaction between a user and the logic configured to operate and control; and
logic configured to enable provision of information regarding print quality issues retrieved from a network, the logic configured to enable provision of information being contained within the logic configured to support interaction.

15. The system of claim 14, wherein the logic configured to operate and control comprises a peripheral device driver.

16. The system of claim 14, wherein logic configured to support interaction comprises a device driver user interface.

17. The system of claim 14, wherein the logic configured to enable provision of information comprises a hyperlink to a network file.

18. The system of claim 17, wherein the logic configured to enable provision of information further comprises a network browser.

19. A peripheral device driver user interface, the interface comprising:
a window that is viewable in a computer display;
information and options associated with the peripheral device and its operation presented within the window; and
a link to network-accessible print quality Support information that aids a user in identifying the cause of a print quality problem.

20. The interface of claim 19, wherein the link comprises a hyperlink to a web file.

21. The interface of claim 20, wherein the hyperlink is associated with a color tab presented in the window.

22. The interface of claim 19, wherein the link is configured to take the user to information regarding at least one of the proper operation of the peripheral device and how to troubleshoot print quality problems.
